(19) United States
(12) Patent Application Publication
(10) Pub. No.: US 2014/0324377 A1
(43) Pub. Date: Oct. 30, 2014

(54) METHODS AND SYSTEMS OF MAKING FATIGUE BLOCK CYCLE TEST SPECIFICATIONS FOR COMPONENTS AND/OR SUBSYSTEMS

(71) Applicant: GM GLOBAL TECHNOLOGY OPERATIONS LLC, Detroit, MI (US)

(72) Inventors: Gary R. FENN, WEST BLOOMFIELD, MI (US); Abolhassan K. KHOSROVANEH, NOVI, MI (US)

(73) Assignee: GM GLOBAL TECHNOLOGY OPERATIONS LLC, Detroit, MI (US)

(21) Appl. No.: 13/873,937

(22) Filed: Apr. 30, 2013

(51) Int. Cl. G01M 17/00

(52) U.S. Cl. CPC G01M 17/00
USPC 702/113

(57) ABSTRACT

Methods of making fatigue block cycle test specifications for components and/or subsystems are provided herein. In one example, the method includes providing a damage histogram having a plurality of block range sections and defining relative damage corresponding with each of a plurality of range-mean pairs. The plurality of range-mean pairs is determined from one or more time histories of road test events. The plurality of range-mean pairs is distributed over the plurality of block range sections. A largest range range-mean pair is selected in an upper-most block range section of the plurality of block range sections. A highest damage value first range-mean pair is selected in an intermediate block range section of the plurality of block range sections.

### TECHNICAL FIELD

The technical field generally relates to durability testing of components and/or subsystems for motor vehicles, and more particularly relates to methods and systems of making fatigue block cycle test specifications for components and/or subsystems, e.g., vehicle components and/or subsystems, aircraft components and/or subsystems, machinery components and/or subsystems, and the like.

### BACKGROUND

The need for vehicle industries to reduce development time of new products has led to improvements of fatigue life prediction methods. These improved fatigue life prediction methods include block cycle tests of various components and/or subsystems (e.g., vehicle components and/or subsystems, aircraft components and/or subsystems, machinery components and/or subsystems, and the like). A block cycle test simplifies real-world load inputs (e.g., road test events encompassing multiple road surfaces including rough roads, potholes, and the like) to assess structural durability. The block cycle test is much shorter and simpler to run than a real-time test of a component or subsystem, and is much more representative than a constant amplitude (e.g., one single cyclic loading) or “bogey” test.

The block cycle test is based on a load matrix, e.g., rainflow cycle count or other approach such as Level Crossing or Peak-Valley Cyclic Count. A block cycle includes a number of load levels, usually defined as a range-mean pair with varying numbers of cycles at each level. Currently, there are no standard procedures for developing block cycle test specifications. Conventional methods are typically not repeatable and the results can be somewhat arbitrary.

Accordingly, it is desirable to provide methods and systems of making fatigue block cycle test specifications for components and/or subsystems that offer a more consistent approach to selecting the load levels for block cycle testing. Furthermore, other desirable features and characteristics of the present invention will become apparent from the subsequent detailed description and the appended claims, taken in conjunction with the accompanying drawings and the foregoing technical field and background.

### BRIEF SUMMARY

Methods of making fatigue block cycle test specifications for components and/or subsystems are provided herein. In one embodiment, the method includes at a processor, providing a damage histogram having a plurality of block range sections and defining relative damage corresponding with each of a plurality of range-mean pairs. At the processor, the plurality of range-mean pairs is determined from one or more time histories of road test events. The plurality of range-mean pairs is distributed over the plurality of block range sections. At the processor, a largest range range-mean pair is selected in an upper-most block range section of the plurality of block range sections. A highest damage value first range-mean pair is selected in an intermediate block range section of the plurality of block range sections.

In another embodiment, a method of making a fatigue block cycle test specification for a component and/or subsystem includes at a processor, providing a composite rainflow matrix. The composite rainflow matrix defines relative counts corresponding with each of a plurality of range-mean pairs. At the processor, the plurality of range-mean pairs is determined from one or more time histories of road test events. A damage histogram that defines relative damage corresponding with each of the plurality of range-mean pairs is produced at the processor using the composite rainflow matrix. At the processor, a plurality of block range sections is defined along the damage histogram such that the plurality of range-mean pairs is distributed over the plurality of block range sections. The plurality of block range sections includes an upper-most block range section, a lower block range section, and a first intermediate block range section that is disposed between the upper-most and the lower block range sections. At the processor, a largest range range-mean pair is selected in the upper-most block range section. A first number of block test cycles associated with the largest range range-mean pair is determined at the processor. At the processor, a highest damage value first range-mean pair is selected in the first intermediate block range section. A second number of block test cycles associated with the highest damage value first range-mean pair is determined at the processor. At the processor, a highest damage value second range-mean pair is selected in the lower block range section. A third number of block test cycles associated with the highest damage value second range-mean pair is determined at the processor.

In another embodiment, a system of making a fatigue block cycle test specification for a component and/or subsystem is provided. The system includes a computer arrangement operative to provide a damage histogram. The damage histogram has a plurality of block range sections and defines relative damage corresponding with each of a plurality of range-mean pairs determined from one or more time histories of road test events. The plurality of range-mean pairs is distributed over the plurality of block range sections. A largest range range-mean pair in an upper-most block range section of the plurality of block range sections is selected. A highest damage value first range-mean pair in an intermediate block range section of the plurality of block range sections is selected.

### BRIEF DESCRIPTION OF THE DRAWINGS

The exemplary embodiments will hereinafter be described in conjunction with the following drawing figures, wherein like numerals denote like elements, and wherein:

FIG. 1 is a graphical representation of a time history of a first road test event in accordance with an exemplary embodiment;

FIG. 2 is a graphical representation of a time history of a second road test event in accordance with an exemplary embodiment;

FIG. 3A is a graphical representation of a concatenated time history of the first and second road test events depicted in FIGS. 1-2;

FIG. 3B is a graphical representation of a residual time history obtained from FIGS. 1-2;

FIGS. 4A-4B are graphical representations of a method of rainflow counting a time history of one or more road test events in which FIG. 4A is not a rainflow cycle while FIG. 4B is a rainflow cycle in accordance with an exemplary embodiment;

FIG. 5 is a graphical representation of a composite rainflow cycle histogram in accordance with an exemplary embodiment;

FIG. 6 is a graphical representation of a damage histogram in accordance with an exemplary embodiment;

FIG. 7 is a flowchart of a method of making a fatigue block cycle test specification for a component and/or subsystem in accordance with an exemplary embodiment; and

FIG. 8 is a computer arrangement for implementing various embodiments of the method depicted in FIG. 7.

### DETAILED DESCRIPTION

The following detailed description is merely exemplary in nature and is not intended to limit the application and uses. Furthermore, there is no intention to be bound by any theory presented in the preceding technical field, background, brief summary or the following detailed description.

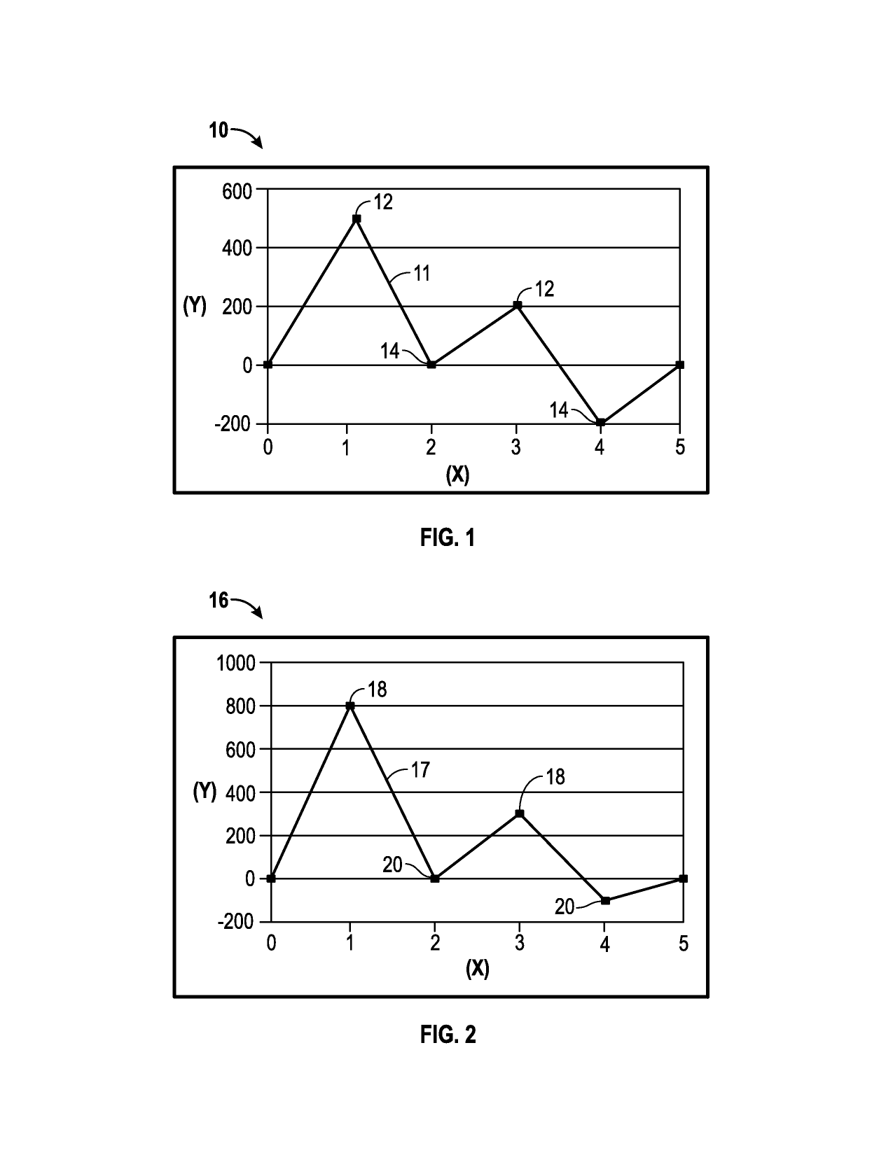

Various embodiments contemplated herein relate to methods and systems of making fatigue block cycle test specifications for components and/or subsystems (e.g., vehicle components and/or subsystems, aircraft components and/or subsystems, machinery components and/or subsystems, and the like). The described method steps and procedures are to be considered only as exemplary embodiments designed to illustrate to one of ordinary skill in the art methods for practicing the invention; the invention is not limited to these exemplary embodiments. For purposes of illustration, FIGS. 1-7 illustrate methods of making fatigue block cycle test specifications. Various steps in the making of fatigue block cycle test specifications are well known and so, in the interest of brevity, many conventional steps will only be mentioned briefly herein or will be omitted entirely without providing the well-known method details.

In the automotive industry or other like vehicle industries, the loading on a component and/or subsystem is defined by a “test schedule” or “durability schedule” that contains multiple events of different loading conditions. A test schedule consists of different sections of a driving proving ground, e.g., road conditions such as rough road, potholes, Belgium blocks, railroad tracks, and the like. During the initial vehicle design phase, load histories or time histories for different events, e.g., driving over rough roads, potholes, Belgium blocks, railroad tracks, etc., are recorded and/or predicted.

Referring to FIG. 1, a time history 10 of a first road test event in accordance with an exemplary embodiment is provided. As illustrated, the time history 10 is an X-, Y-axes graphical representation in which the X-axis represents time and the Y-axes represents microstrain. The time history 10 is representative of the strain loading history of any component or vehicle subsystem recorded during a particular event. For the purposes of discussion only, the time history 10 will represent a ball joint force time-history over driving proving ground conditions consisting of Belgium blocks. The time history 10 includes a curve 11 with a plurality of peaks 12 and valleys 14. Although the time history 10 is shown as having only a few peaks 12 and valleys 14, it is to be understood that an actual time history of an event may have from hundreds to tens of millions of peaks and valleys.

Referring to FIG. 2, a time history 16 of a second road test event in accordance with an exemplary embodiment is provided. As illustrated, the time history 16 is an X-, Y-axes graphical representation in which the X-axis represents time and the Y-axes represents microstrain. The time history 16 is representative of the strain loading history of any component or subsystem recorded during a particular event. For the purposes of discussion only, the time history 16 will represent the same component represented in the time history 10, e.g., a ball joint force time-history, but over a different driving proving ground condition such as consisting of potholes. The time history 16 includes a curve 17 with a plurality of peaks 18 and valleys 20. As noted above, although the time history 16 is shown as having only a few peaks 18 and valleys 20, it is to be understood that an actual time history for a single event may have from hundreds to tens of millions of peaks and valleys.

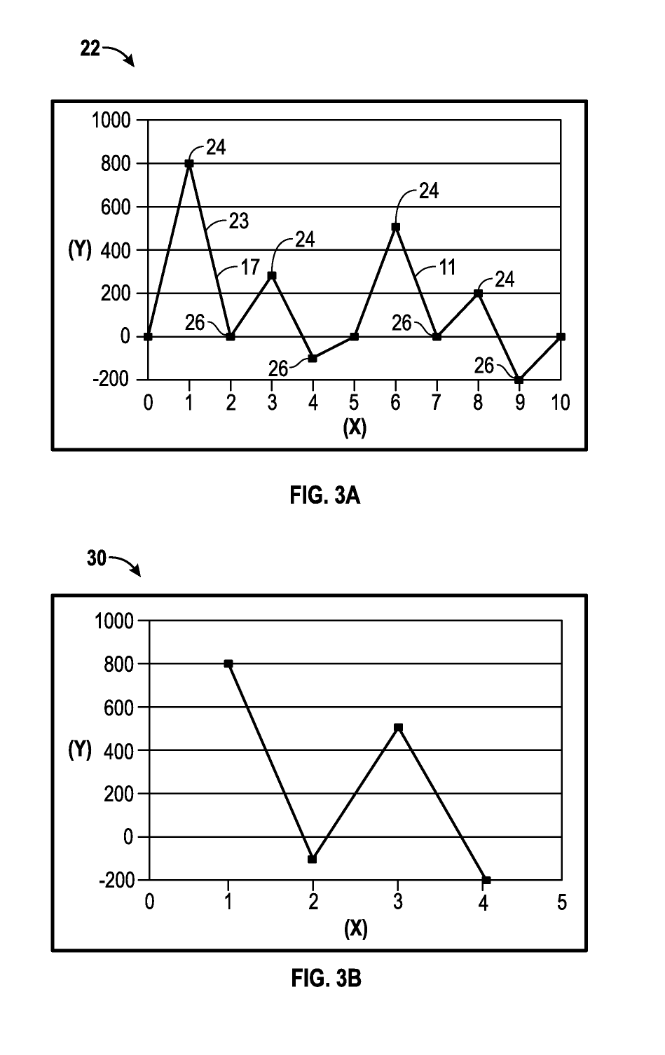

Referring to FIG. 3A, a concatenated time history 22 of the time histories 10 and 16 in accordance with an exemplary embodiment is provided. The concatenated time history 22 is a concatenating loading history of the time history 16 illustrated in FIG. 2 followed by the time history 10 illustrated in FIG. 1. As such, the concatenated time history 22 is an X-, Y-axes graphical representation in which the X-axis represents time and the Y-axes represents microstrain. The concatenated time history 22 includes a curve 23 corresponding to curves 11 and 17 connected together with a plurality of peaks 24 that correspond to peaks 12 and 18 and valleys 26 that correspond to valleys 14 and 20. Although the concatenated time history 22 is shown as having only relatively few peaks 24 and valleys 26, it is to be understood that an actual concatenated time history for multiple events may have from hundreds to hundreds of millions of peaks and valleys.

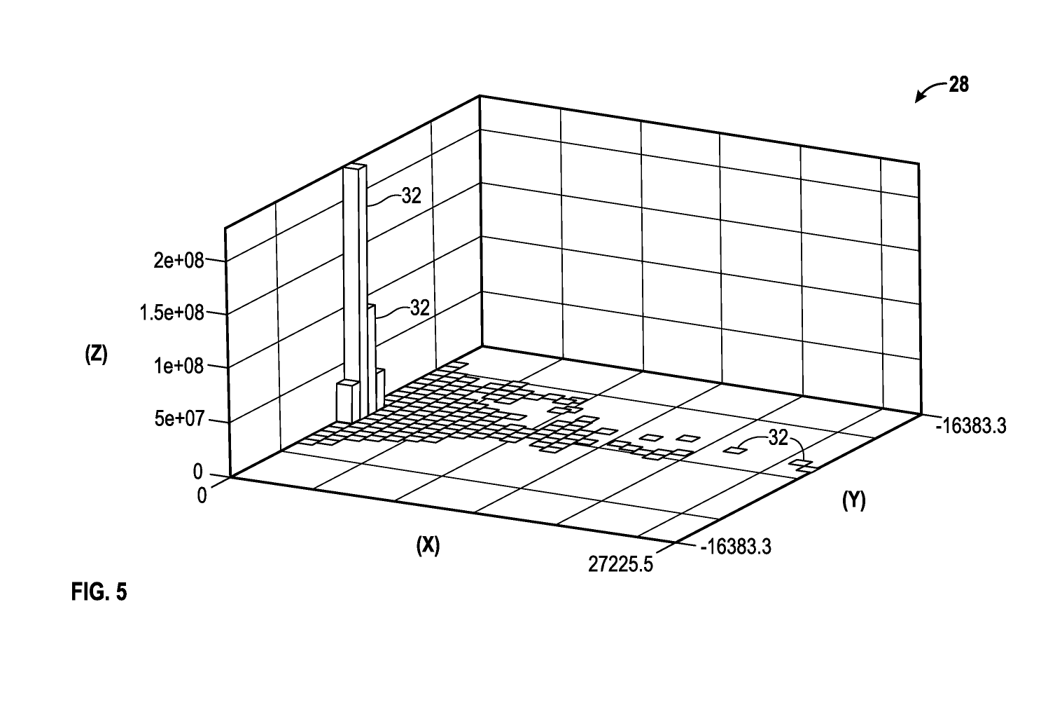

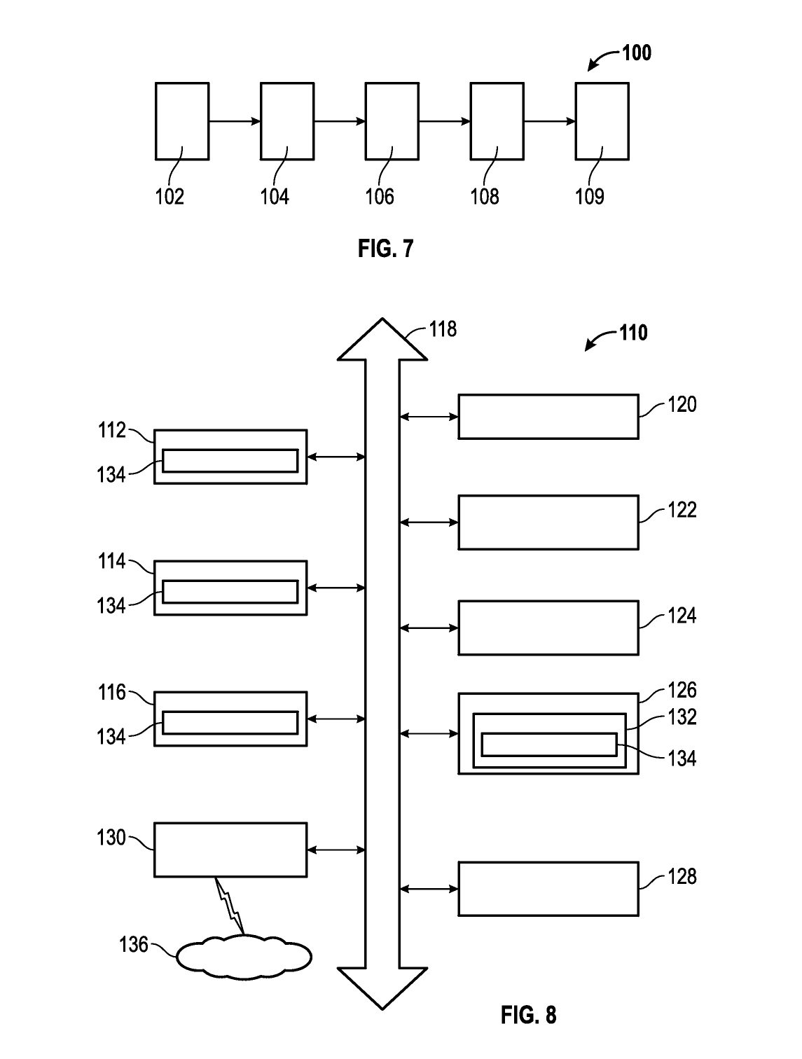

FIG. 7 illustrates a method 100 of making a fatigue block cycle test specification for a component and/or subsystem in accordance with an exemplary embodiment. Referring to FIGS. 1-3 and 7, the time histories 10, 16, and/or 22 are rainflow counted to provide a composite rainflow matrix (step 102). Note and as will be discussed in further detail below, an example of a composite rainflow matrix 28 (also referred to as a “composite rainflow histogram”) is provided in FIG. 5. In particular, the fatigue life of a component and/or subsystem can be predicted by applying rainflow cycle counting (also referred to herein as “rainflow counting”) to the time histories 10, 16, and/or 22 and recording the results in a matrix that gives the relative number of cycles at various combinations of peaks and valleys (e.g., ranges and means) loads. Rainflow counting is well known in the art and the following example, in the interest of brevity, is described only briefly herein without necessarily providing all of the well-known details.

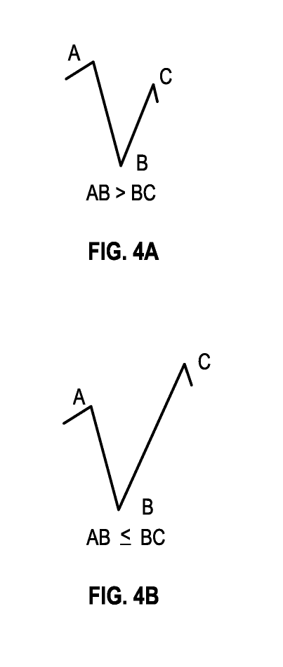

In an exemplary embodiment, a rainflow count is performed on the time histories 10 and 16. Note that in typical rainflow counting methods, cycles are first arranged to start and end with the maximum absolute value point. Cycles are counted depending on a comparison of two adjacent ranges in accordance with FIGS. 4A-4B that also define the range and mean of a cycle. In particular and as illustrated in FIG. 4B, if a first range (AB) is less than or equal to a second range (BC), the cycle (AB) is counted as a rainflow cycle and the corresponding peak (A) and valley (B) are discarded for the purpose of further cycle counting. Likewise and as illustrated in FIG. 4A, if the first range (AB) is more than the second range (BC), the cycle (AB) is not counted as a rainflow cycle and the corresponding peak (A) and valley (B) are available for the purpose of further cycle counting. This procedure continues until all peaks 12, 18, and/or 24 and valleys 14, 20, and/or 26 in the time history 10, 16, and/or 22 are considered.

The rainflow matrix obtained from the concatenated time history 22 is different from the rainflow results obtained by adding the rainflow cycles of the time histories 10 and 16. Table 1 (see below) shows the rainflow cycles of the time histories 10 and 16. Table 2 (see below) shows the rainflow cycles for the concatenated time history 22. As can be seen, the two rainflow results from Table 1 (column 3—i.e., Time Histories 16+10) and Table 2 are not identical.

Consider the time histories 10 and 16 are arranged to start with the maximum absolute value point but do not end with the maximum absolute value point. In the time history 10, since the maximum value was not added as the last point, one cycle does not close. This causes two remaining points that do not form a rainflow cycle, i.e., 500 and −200. These points are called residual points. Similarly, in time history 16, the residual points are 800 and −100. Table 3 shows the rainfall results without ending the time histories 10 and 16 with maximum values. The next step is to reconstruct a time history with residuals. FIG. 3B illustrates a reconstructed time history or residual time history 30 of the residual points for the time history 16 followed by the time history 10.

Table 4 shows the residual rainflow cycles of the residual time history 30. A composite rainflow matrix, for example similar to the composite rainflow matrix 28 shown in FIG. 5, can be attained by combining the rainflow cycles of the time histories 10 and 16 from Table 3 with the residual rainflow cycles of residual time history 30 from Table 4. The summing of the rainflow matrices by including the residual cycles produces a composite rainflow matrix that is identical to the matrix obtained from the concatenated time history 22 and thus, either approach to rainflow counting may be used to provide a composite rainflow matrix.

Tables:

TABLE 1

| Time History 10 | | | Time History 16 | | | Rainflow Cycles of Time | | |
|---|---|---|---|---|---|---|---|---|
| | | Cy- | | | Cy- | Histories 16 + 10 | | |
| Range | Mean | cles | Range | Mean | cles | Range | Mean | Cycles |
| 200 | 100 | 1 | 300 | 150 | 1 | 200 | 100 | 1 |
| 700 | 150 | 1 | 900 | 350 | 1 | 300 | 150 | 1 |
| | | | | | | 700 | 150 | 1 |
| | | | | | | 900 | 350 | 1 |

TABLE 2
Rainflow Cyces of Time History 10 and Time History 16

| Range | Mean | Cycles |
|---|---|---|
| 200 | 100 | 1 |
| 300 | 150 | 1 |
| 600 | 200 | 1 |
| 1000 | 300 | 1 |

TABLE 3

| Time History 10 - | | | Time History 16 - | | |
|---|---|---|---|---|---|
| Without Ending with | | | Without Ending with | | |
| the Maximum Point | | | the Maximum Point | | |
| Range | Mean | Cycles | Range | Mean | Cycles |
| 200 | 100 | 1 | 300 | 150 | 1 |

TABLE 4
Residual Time History 30

| Range | Mean | Cycles |
|---|---|---|
| 600 | 200 | 1 |
| 1000 | 300 | 1 |

Referring to FIG. 5, a graphical representation of the composite rainflow matrix 28 in accordance with an exemplary embodiment is provided. As illustrated, the composite rainflow matrix 28 is configured as a 3-D, X-, Y-, Z-axes matrix in which the X-axes represents range in newton (N), the Y-axis represents mean (N), and the Z-axis represents relative cycles (counts). In an exemplary embodiment, the composite rainflow matrix 28 is configured as a 32×32 range versus mean bin matrix in which the X-axis has 32 range bins and the Y-axis has 32 mean bins for assigning range-mean pairs determined from rainflow counting the time histories 10, 16, and/or 22. Alternatively, the composite rainflow matrix 28 may be configured as a different size range versus mean bin matrix, such as, for example, a 64×64 range versus mean bin matrix, 128×128 range versus mean bin matrix, or any other suitable size range versus mean bin matrix. As illustrated, each bin 32 is defined by corresponding range-mean pairs (i) that together define a count or number of cycles (nᵢ) associated with the particular bin 32.

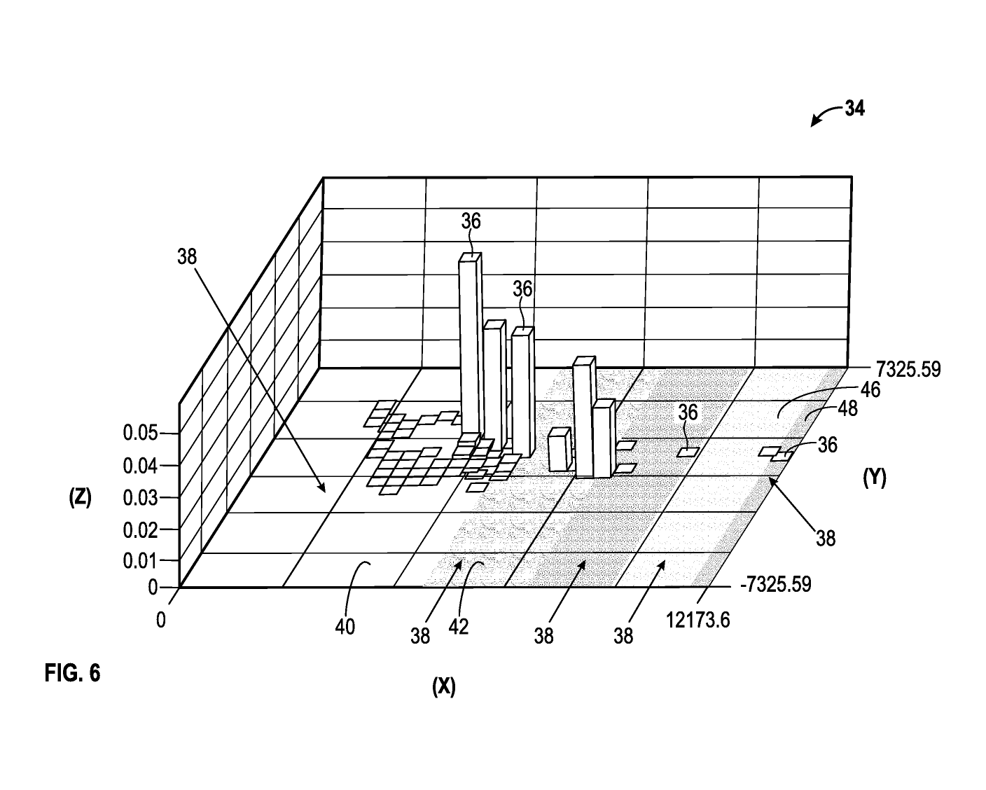

Referring to FIGS. 6-7, the method 100 continues by producing a damage histogram 34 (also called a damage matrix) that defines relative damage (Dᵢ) corresponding with each of the plurality of range-mean pairs (i) (step 104) using the composite rainflow matrix 28. In an exemplary embodiment, the composite rainflow matrix 28 is used to back-calculate a scale factor using strain life calculations (e.g., using well-known approaches such as the Neuber-method, Morrow Mean-Stress Corrections, and/or Miner's Rule) that include the proper material, mean stress, and assumed fatigue life for the particular component or vehicle subsystem, e.g., for a ball joint component, etc. In one embodiment, a scale factor (Life) of 2 or 3 is used to provide a proving ground life of about 200% or 300% (e.g., corresponding to about 200,000 or about 300,000 vehicle miles) respectively for reliability reasons. In an exemplary embodiment, the following expression is used to determine the relative damage or damage value (Dᵢ) of the range-mean pairs (i) for a particular bin 36:

1/Life=ΣDᵢ=Σnᵢ/Nᵢ

wherein the Σ is the summation, for example, from i=1 to i=32 (e.g., for a 32×32 matrix as discussed in further detail below but will differ for a different sized matrix) and Nᵢ is the fatigue life value. In an exemplary embodiment, the fatigue life value (Nᵢ) is calculated using well-known fatigue life approaches such as the Coffin Manson equation with Neuber method correction for the particular component or subsystem.

As illustrated, the damage histogram 34 is configured as a 3-D, X-, Y-, Z-axes matrix in which the X-axes represents range in newton (N), the Y-axis represents mean (N), and the Z-axis represents relative damage (Dᵢ). In an exemplary embodiment, the damage histogram 34 is configured as a 32×32 range versus mean bin matrix in which the X-axis has 32 range bins and the Y-axis has 32 mean bins for the corresponding range-mean pairs (i) determined in the composite rainflow matrix 28. Alternatively, the damage histogram 34 may be configured as a different size range versus mean bin matrix, such as, for example, a 64×64 range versus mean bin matrix, 128×128 range versus mean bin matrix, or any other suitable size range versus mean bin matrix. Each bin 36 is defined by corresponding range-mean pairs (i) that are associated with a particular bin 32 from the composite rainflow matrix 28 and the relative damage (Di) associated with the particular bin 36.

In an exemplary embodiment, the method 100 continues by defining a plurality of block range sections 38 (step 106) along the damage histogram 34 such that the bins 36 (i.e., range-mean pairs (i)) are distributed over the block range sections 38. In an exemplary embodiment, the damage histogram 34 is a 32×32 range versus mean bin matrix having 32 range bins that are subdivided into a lower block range section 40 that includes block range sections 1-13, a first intermediate block range section 42 that includes block range sections 14-19, a second intermediate block range section 44 that includes block range sections 20-25, a third intermediate block range section 46 that includes block range sections 26-31, and an upper-most block range section 48 that includes block range section 32.

The method 100 continues by selecting specific range-mean pairs in each of the block range sections 38 (step 108). In an exemplary embodiment, the method includes the following steps for selecting the specific range-mean pairs:
(1) In the upper-most block range section 48, the bin 36 corresponding to the range-mean pair with the largest range is selected to define a largest range range-mean pair.
(2) In the third intermediate block range section 46, the two most damaging range-mean pairs (e.g., two most damaging range-mean amplitudes or values) are examined. In an exemplary embodiment, the bin 36 with the highest damage value range-mean pair is selected, and if the second highest damage value range-mean pair is not adjacent to the highest damage value range-mean pair, then the second highest damage value range-mean pair is also selected to define a top 1 or 2 highest damage value first range-mean pairs. If the second highest damage value range-mean pair is adjacent to the highest damage value range-mean pair, then the 2 highest damage value range mean pairs may be combined.
(3) In the second intermediate block range section 44, step 2 is repeated to define a top 1 or 2 highest damage value second range-mean pairs.
(4) In the first intermediate block range section 42, the bin 36 with the highest damage value range-mean pair is selected to define a highest damage value third range-mean pair.
(5) In the lower block range section 40, if the damage is not zero, the bin 36 with the highest damage value range-mean pair is selected to define a highest damage value fourth range-mean pair.

In an exemplary embodiment, the method 100 continues by determining the number of block test cycles (step 109) associated with each of the specific range-mean pairs selected for each of the block range sections 38 to define a fatigue block cycle test specification. In an exemplary embodiment, the method includes the following steps for determining the number of block test cycles:
(6) For the upper-most block range section 48, summing the total damage (D_{T(U-M)}) in the upper-most block range section 48 and multiplying the fatigue life value (N_{HR}) associated with the largest range range-mean pair to determine a number of block test cycles associated with the largest range range-mean pair.
(7) For the third intermediate block range section 46, if only the top 1 highest damage value first range-mean pair is selected, then summing the total damage (D_{T1a}) in the third intermediate block range section 46 and multiplying the first fatigue life value (N₁ₐ) associated with the highest damage value first range-mean pair to determine a number of block test cycles associated with the highest damage value first range-mean pair; and if the top 2 highest damage value first range-mean pairs are selected, then providing a first number of cycle counts (n₁ₐ) associated with the highest damage value first range-mean pair from the composite rainflow matrix 28 and a second number of cycle counts (n₂ₐ) associated with the second highest damage value first range-mean pair from the composite rainflow matrix 28, dividing the first number of cycle counts (n₁ₐ) by a first fatigue life value (N₁ₐ) associated with the highest damage value first range-mean pair to define a first damage value (D₁ₐ) associated with the highest damage value first range-mean pair, dividing the second number of cycle counts (n₂ₐ) by a second fatigue life value (N₂ₐ) associated with the second highest damage value first range-mean pair to define a second damage value (D₂ₐ) associated with the second highest damage value first range-mean pair, and determining a number of block test cycles (m₁ₐ) associated with the highest damage value first range-mean pair according to a first relationship:

m₁ₐ=Rₐ*D_{T1a}*n₁ₐ/D₁ₐ, wherein Rₐ=D₁ₐ/(D₁ₐ+D₂ₐ), and
determining a number of block test cycles (m₂ₐ) associated with the second highest damage value first range-mean pair according to a second relationship:

m₂ₐ=(1−Rₐ)*D_{T1a}*n₂ₐ/D₂ₐ.
(8) For the second intermediate block range section 44, if only the top 1 highest damage value second range-mean pair is selected, then summing the total damage (D_{T1b}) in the second intermediate block range section 44 and multiplying the first fatigue life value (N_{1b}) associated with the highest damage value second range-mean pair to determine a number of block test cycles associated with the highest damage value second range-mean pair; and if the top 2 highest damage value second range-mean pairs are selected, then providing a first number of cycle counts (n_{1b}) associated with the highest damage value second range-mean pair from the composite rainflow matrix 28 and a second number of cycle counts (n_{2b}) associated with the second highest damage value second range-mean pair from the composite rainflow matrix 28, dividing the first number of cycle counts (n_{1b}) by a first fatigue life value (N_{1b}) associated with the highest damage value first range-mean pair to define a first damage value (D_{1b}) associated with the highest damage value first range-mean pair, dividing the second number of cycle counts (n_{2b}) by a second fatigue life value (N_{2b}) associated with the second highest damage value first range-mean pair to define a second damage value (D_{2b}) associated with the second highest damage value second range-mean pair, and determining a number of block test cycles (m_{1b}) associated with the highest damage value second range-mean pair according to a first relationship:

m_{1b}=R_{b}*D_{T1b}*n_{1b}/D_{1b}, wherein R_{b}=D_{1b}/(D_{1b}+D_{2b}), and
determining a number of block test cycles (m_{2b}) associated with the second highest damage value second range-mean pair according to a second relationship:

m_{2b}=(1−R_{b})*D_{T1b}*n_{2b}/D_{2b}.
(9) For the first intermediate block range section 42, summing the total damage (D_{T1c}) in the first intermediate block range section 42 and multiplying the fatigue life value (N_{1c}) associated with the highest damage value third range-mean pair to determine a number of block test cycles associated with the highest damage value third range-mean pair.
(10) For the lower block range section 40, determining a combined total damage (D_{Total}) of the plurality of block range sections 38, determining a total damage (D_{T(L-M}) of the lower block range section 40, and if the total damage (D_{T(L-M}) is about 2% or less of the combined total damage (D_{Total}), then assigning a predetermined number of cycles, such as, for example 10,000 to the number of block test cycles; and if the total damage (D_{T(L-M}) is greater than about 2% of the combined total damage(D_{Total}), then multiplying the total damage (D_{T(L-M}) by a fatigue life value associated with the highest damage value fourth range-mean pair.

The following is an example of a fatigue block cycle test specification for a component and/or subsystem in accordance with an exemplary embodiment. The example is provided for illustration purposes only and is not meant to limit the various embodiments in any way.

### Example

### Block Cycle Test Specification for a Ball Joint Load

| | | | Number of | Damage per |
|---|---|---|---|---|
| Load Level | Range (N) | Mean (N) | Cycles | Cycle |
| 1 | 2.68E4 | 2560 | 2 | 6.574E−4 |
| 2 | 2.595E4 | 3584 | 2 | 5.939E−4 |
| 3 | 2.17E4 | 3584 | 3 | 3.065E−4 |
| 4 | 1.744E4 | 512 | 628 | 1.106E−4 |
| 5 | 1.574E4 | 1536 | 998 | 6.953E−5 |
| 6 | 1.063E4 | 4608 | 30417 | 8.462E−6 |
| 7 | 9784 | −512 | 10000 | 0 |

Referring to FIG. 8, an illustrative embodiment of a general computer arrangement is shown and is designated 110. The computer arrangement 110 can include a set of instructions that can be executed to cause the computer arrangement 110 to perform any one or more of the system methods or computer based functions disclosed herein. The computer arrangement 110 may operate as a standalone device or may be connected, e.g., using a network, to other computer arrangements or peripheral devices.

In a networked deployment, the computer arrangement may operate in the capacity of a server or as a client user computer in a server-client user network environment, or as a peer computer arrangement in a peer-to-peer (or distributed) network environment. The computer arrangement 110 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer arrangement 110 can be implemented using electronic devices that provide voice, video or data communication. Further, while a single computer arrangement 110 is illustrated, the term “arrangement” shall also be taken to include any collection of systems or sub-systems that individually or jointly execute a set, or multiple sets, of instructions to perform one or more computer functions.

As illustrated, the computer arrangement 110 may include a processor 112, e.g., a central processing unit (CPU), a graphics processing unit (GPU), or both. Moreover, the computer arrangement 110 can include a main memory 114 and a static memory 116 that can communicate with each other via a bus 118. As shown, the computer arrangement 110 may further include a video display unit 120, such as a liquid crystal display (LCD), an organic light emitting diode (OLED), a flat panel display, a solid state display, or a cathode ray tube (CRT). Additionally, the computer arrangement 110 may include an input device 122, such as a keyboard, and a cursor control device 124, such as a mouse. The computer arrangement 110 can also include a disk drive unit 126, a signal generation device 128, such as a speaker or remote control, and a network interface device 130.

In a particular embodiment, the disk drive unit 126 may include a computer-readable medium 132 in which one or more sets of instructions 134, e.g., embodiments of methods of making fatigue lock cycle test specifications, can be embedded. Further, the instructions 134 may embody one or more of the methods or logic as described herein. In a particular embodiment, the instructions 134 may reside completely, or at least partially, within the main memory 114, the static memory 116, and/or within the processor 112 during execution by the computer arrangement 110. The main memory 114 and the processor 82 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer arrangements. One or more embodiments described herein may implement functions using two or more specific interconnected hardware modules or devices with related control and data signals that can be communicated between and through the modules, or as portions of an application-specific integrated circuit. Accordingly, the present arrangement encompasses software, firmware, and hardware implementations.

In accordance with various embodiments of the present disclosure, the methods described herein may be implemented by software programs executable by the computer arrangement 110. Further, in an exemplary, non-limited embodiment, implementations can include distributed processing, component/object distributed processing, and parallel processing. Alternatively, virtual computer arrangement processing can be constructed to implement one or more of the methods or functionality as described herein.

The present disclosure contemplates a computer-readable medium that includes instructions 134 or receives and executes instructions 134 responsive to a propagated signal so that a device connected to a network 136 can communicate voice, video or data over the network 136. Further, the instructions 134 may be transmitted or received over the network 136 via the network interface device 130.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer arrangement to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

Accordingly, methods and systems of making fatigue lock cycle test specifications for components and/or subsystems have been described. Various embodiments include providing a damage histogram having a plurality of block range sections. The damage histogram defines relative damage corresponding with each of a plurality of range-mean pairs. The plurality of range-mean pairs is determined from one or more time histories of road test events. The plurality of range-mean pairs is distributed over the plurality of block range sections. A largest range range-mean pair is selected in an upper-most block range section of the plurality of block range sections. A highest damage value first range-mean pair is selected in an intermediate block range section of the plurality of block range sections.

While at least one embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes may be made in the function and arrangement of elements without departing from the scope of the disclosure as set forth in the appended claims and the legal equivalents thereof

What is claimed is:

1. A method of making a fatigue block cycle test specification for a component and/or subsystem, the method comprising the steps of:
at the processor, providing a damage histogram having a plurality of block range sections and defining relative damage corresponding with each of a plurality of range-mean pairs determined from one or more time histories of road test events, wherein the plurality of range-mean pairs is distributed over the plurality of block range sections;
at the processor, selecting a largest range range-mean pair in an upper-most block range section of the plurality of block range sections; and
at the processor, selecting a highest damage value first range-mean pair in an intermediate block range section of the plurality of block range sections.

2. The method of claim 1, wherein the step of selecting the highest damage value first range-mean pair comprises selecting the highest damage value first range-mean pair and a second highest damage value first range-mean pair in the intermediate block range section.

3. The method of claim 1, further comprising the steps of:
at the processor, determining a first number of block test cycles associated with the largest range range-mean pair; and/or
at the processor, determining a second number of block test cycles associated with the highest damage value first range-mean pair.

4. The method of claim 3, wherein the step of determining the first number of block test cycles comprises:
determining a first total damage for the upper-most block range section; and
multiplying the first total damage by a first fatigue life value associated with the largest range range-mean pair.

5. The method of claim 3, wherein the step of determining the second number of block test cycles comprises:
determining a second total damage for the intermediate block range section; and
multiplying the second total damage by a second fatigue life value associated with the highest damage value first range-mean pair.

6. The method of claim 1, further comprising the step of:
at the processor, selecting a highest damage value second range-mean pair in a lower block range section of the plurality of block range sections.

7. The method of claim 6, further comprising the step of:
at the processor, determining a third number of block test cycles associated with the highest damage value second range-mean pair.

8. The method of claim 7, wherein the step of determining the third number of block test cycles comprises:
determining a combined total damage of the plurality of block range sections;
determining a third total damage of the lower block range section, and wherein if the third total damage is about 2% or less of the combined total damage, then assigning a predetermined number of cycles to the third number of block test cycles.

9. The method of claim 8, wherein the step of determining the third number of block test cycles comprises assigning the predetermined number of cycles of about 10,000 to the third number of block test cycles.

10. The method of claim 8, wherein the step of determining the third number of block test cycles comprises multiplying the third total damage by a third fatigue life value associated with the highest damage value second range-mean pair if the third total damage is greater than about 2% of the combined total damage.

11. A method of making a fatigue block cycle test specification for a component and/or subsystem, the method comprising the steps of:
at a processor, providing a composite rainflow matrix that defines relative counts corresponding with each of a plurality of range-mean pairs determined from one or more time histories of road test events;
at the processor, producing a damage histogram that defines relative damage corresponding with each of the plurality of range-mean pairs using the composite rainflow matrix;
at the processor, defining a plurality of block range sections along the damage histogram such that the plurality of range-mean pairs is distributed over the plurality of block range sections, wherein the plurality of block range sections comprises an upper-most block range section, a lower block range section, and a first intermediate block range section that is disposed between the upper-most and the lower block range sections;
at the processor, selecting a largest range range-mean pair in the upper-most block range section;
at the processor, determining a first number of block test cycles associated with the largest range range-mean pair;
at the processor, selecting a highest damage value first range-mean pair in the first intermediate block range section;
at the processor, determining a second number of block test cycles associated with the highest damage value first range-mean pair;
at the processor, selecting a highest damage value second range-mean pair in the lower block range section; and
at the processor, determining a third number of block test cycles associated with the highest damage value second range-mean pair.

12. The method of claim 11, wherein the step of producing the damage histogram comprises producing the damage histogram using the composite rainflow matrix and strain life fatigue calculations.

13. The method of claim 11, wherein the step of determining the second number of block test cycles comprises:
summing a first total damage of the first intermediate block range section;
multiplying the first total damage by a first fatigue life value associated with the highest damage value first range-mean pair to define the second number of block test cycles.

14. The method of claim 11, wherein the step of selecting the highest damage value first range-mean pair further comprises selecting a second highest damage value first range-mean pair in the first intermediate block range section.

15. The method of claim 14, wherein if the first and second highest damage value first range-mean pairs are adjacent to each other, then the first and second highest damage value first range-mean pairs are combined to form a combined second highest damage value first range-mean pairs, and wherein determining the second number of block test cycles comprises determining the second number of block test cycles associated with the combined highest damage value first range-mean pair.

16. The method of claim 14, wherein the step of providing the composite rainflow matrix comprises providing a first number of cycle counts (n₁) associated with the highest damage value first range-mean pair and a second number of cycle counts (n₂) associated with the second highest damage value first range-mean pair, wherein the step of producing the damage histogram comprises;
dividing the first number of cycle counts (n₁) by a first fatigue life value (N₁) associated with the highest damage value first range-mean pair to define a first damage value (D₁) associated with the highest damage value first range-mean pair; and
dividing the second number of cycle counts (n₂) by a second fatigue life value (N₂) associated with the second highest damage value first range-mean pair to define a second damage value (D₂) associated with the second highest damage value first range-mean pair, and wherein the step of determining the second number of block test cycles comprises:
determining the second number of block test cycles (mᵢ) according to a first relationship:
m₁=R*D_{T1}*n₁/D₁, wherein R=D₁/(D₁+D₂) and D_{T1}=total
relative damage in the first intermediate block range section; and
determining a fourth number of block test cycles (m₂) associated with the second highest damage value first range-mean pair according to a second relationship:
m₂=(1−R)*D_{T1}*n₂/D₂.

17. The method of claim 11, further comprising the steps of:
at the processor, selecting a corresponding highest damage value range-mean pair in each of one or more additional intermediate block range sections of the plurality of block range sections, wherein the one or more additional intermediate block range sections are disposed between the upper-most and the lower block range sections; and
at the processor, determining a corresponding number of block test cycles associated with each of the corresponding highest damage value range-mean pairs.

18. The method of claim 11, wherein the step of defining the plurality of block range sections comprises defining a total of five block range sections.

19. The method of claim 11, wherein the step of producing the damage histogram comprises producing the damage histogram configured as a 32×32 range versus mean bin matrix.

20. A system of making a fatigue lock cycle test specification for a component and/or subsystem, the system comprising;
a computer arrangement operative to:
provide a damage histogram having a plurality of block range sections and defining relative damage corresponding with each of a plurality of range-mean pairs determined from one or more time histories of road test events, wherein the plurality of range-mean pairs is distributed over the plurality of block range sections;
select a largest range range-mean pair in an upper-most block range section of the plurality of block range sections; and
select a highest damage value first range-mean pair in an intermediate block range section of the plurality of block range sections.
